(19) United States
(12) Patent Application Publication
(10) Pub. No.: US 2021/0268335 A1
(43) Pub. Date: Sep. 2, 2021

(54) EXERCISE THERAPY DEVICE

(71) Applicant: Mitsubishi Electric Engineering Company, Limited, Tokyo (JP)

(72) Inventor: Isao MIZUKURA, Tokyo (JP)

(73) Assignee: Mitsubishi Electric Engineering Company, Limited, Tokyo (JP)

(21) Appl. No.: 17/258,178

(22) PCT Filed: Aug. 3, 2018
(86) PCT No.: PCT/JP2018/029252

§ 371 Date: Jan. 6, 2021

(51) Int. Cl. A63B 24/00; A63B 22/06

(52) U.S. Cl. CPC A63B 24/0087; A63B 22/0605; A63B 2220/54; A63B 2024/0093; A63B 24/0062

(57) ABSTRACT

Provided is an exercise therapy device capable of more appropriately adjusting a load on an exercising person. An exercise therapy device (10) includes torque detection means (13) and control means (12). The torque detection means (13) is configured to detect a torque applied to a rotation portion (11). The control means (12) is configured to execute processing for changing a motion speed of the rotation portion (11) based on a force reference and the detected torque.

### TECHNICAL FIELD

The present invention relates to an exercise therapy device.

### BACKGROUND ART

An exercise therapy device is a device for achieving, for example, maintenance or recovery of a skeletal muscle force. The exercise therapy device includes a movable portion, and is configured to instruct a user to repeat an exercise of applying a force to the movable portion. As the exercise to be repeated, for example, an action of pedaling by both of the legs is known.

The exercise therapy device is used to perform, for example, an isokinetic exercise or a power instruction exercise. The isokinetic exercise means an exercise of moving the movable portion at a constant speed, and refers to, for example, an exercise of a circular motion of pedals at a constant speed. Moreover, the power instruction exercise means an exercise of applying constant work to the movable portion. In the power instruction exercise, there may be output information for instructing a change in motion speed so that work (or a work amount in a unit time) is constant, depending on the magnitude of a force applied to the movable portion by an exercising person.

As a publicly known exercise therapy device, for example, there is an ergometer described in Patent Literature 1.

### CITATION LIST

### Patent Literature

[PTL 1] JP 2015-173859 A

### SUMMARY OF INVENTION

### Technical Problem

However, the related-art exercise therapy device has a problem in that an adjustment of a load on the exercising person is difficult.

For example, in the isokinetic exercise, the same force may not be applied as usual even when the pedals are rotated at the same speed as usual due to, for example, a change in physical condition of the exercising person. In this case, the load is insufficient, and an effect of the exercise may thus be reduced or lost. In the isokinetic exercise using the related-art exercise therapy device, a load equivalent in magnitude to a force exerted by the exercising person is applied. Thus, the load depends on the exercising person, and this insufficiency in load cannot be solved.

In view of the above-mentioned problem, the present invention has an object to provide an exercise therapy device capable of more appropriately adjusting a load on an exercising person.

### Solution to Problem

In order to solve the above-mentioned problem, according to one embodiment of the present invention, there is provided an exercise therapy device including a movable portion, the exercise therapy device including: force detection means for detecting a force applied to the movable portion; and control means for executing processing for changing a motion speed of the movable portion based on a force reference and the detected force.

According to a specific aspect of the present invention, the control means is configured to: increase the motion speed of the movable portion when the detected force is larger than the force reference; and reduce the motion speed of the movable portion when the detected force is smaller than the force reference.

According to a specific aspect of the present invention, the movable portion is configured to execute a circular motion, and the force is represented as a torque.

According to a specific aspect of the present invention, the exercise therapy device is configured to operate in a force reference determination mode and an exercise provision mode, and the control means is configured to: determine the force reference based on the detected force in the force reference determination mode; and execute the processing for changing the motion speed of the movable portion in the exercise provision mode.

### Advantageous Effects of Invention

The exercise therapy device according to the present invention can more appropriately adjust the load on the exercising person.

### BRIEF DESCRIPTION OF DRAWINGS

FIG. 1 is a diagram for illustrating an example of how to use an exercise therapy device according to a first embodiment of the present invention.

FIG. 2 is a diagram for illustrating an example of a configuration of the exercise therapy device of FIG. 1.

FIG. 3 is a graph for showing an example of an F-V characteristic of an isokinetic exercise.

FIG. 4 is a flowchart for illustrating an example of a flow of processing by the exercise therapy device of FIG. 1.

FIG. 5 is a flowchart for illustrating an example of a flow of processing in a torque reference determination mode by an exercise therapy device according to a third embodiment of the present invention.

### DESCRIPTION OF EMBODIMENTS

Now, embodiments of the present invention are described with reference to the accompanying drawings.

### First Embodiment

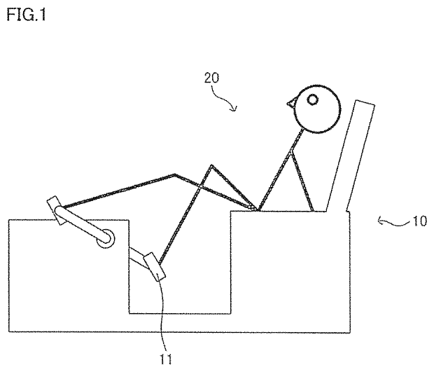

FIG. 1 is a diagram for illustrating an example of how to use an exercise therapy device 10 according to a first embodiment of the present invention. The exercise therapy device 10 includes a movable portion. The movable portion is formed as, for example, a rotation portion 11 capable of performing a circular motion. In the example of FIG. 1, the rotation portion 11 is a pair of pedals, and can be moved by an exercising person 20 applying a torque by the legs. A mechanical configuration of the exercise therapy device 10 may be designed based on a publicly-known exercise therapy device.

The exercising person 20 can perform exercise therapy through use of the exercise therapy device 10. In particular, in this embodiment, the exercise therapy device 10 is configured to be able to provide an isokinetic exercise. Moreover, the exercise therapy device 10 is configured to control the motion of the rotation portion 11, to thereby be able to adjust a load on the exercising person 20. For example, in general, when the rotational speed of the rotation portion 11 is increased in the isokinetic exercise, the load on the exercising person 20 decreases, and when the rotational speed of the rotation portion 11 is reduced, the load on the exercising person 20 increases (force-speed relationship, see “Exercise therapy Guide,” Inoue, Hajime et al., Japan Medical Journal, Third edition, p. 66, 2000). Herein, “isokinetic exercise” sometimes includes a circular motion (constant-velocity circular motion) at a constant angular velocity.

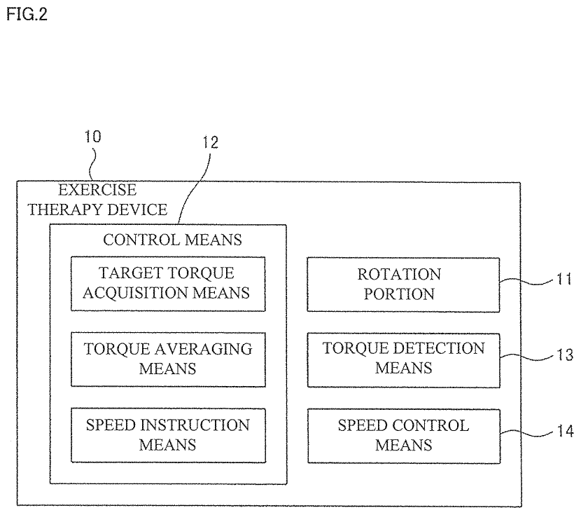

FIG. 2 is a diagram for illustrating an example of a configuration of the exercise therapy device 10. The exercise therapy device 10 includes control means 12. The control means 12 is formed of, for example, a computer, and is configured to control an operation of the exercise therapy device 10. A computer having a publicly-known configuration can be used as the computer, but the computer may be, for example, a computer including calculation means (such as a CPU or other processor) and storage means (such as a semiconductor memory or an HDD). When the exercise therapy device 10 operates, the control means 12 operates as target torque acquisition means, torque averaging means, and speed instruction means (a detailed description thereof is given later). In other words, it can be considered that the exercise therapy device 10 includes the target torque acquisition means, the torque averaging means, and the speed instruction means.

Moreover, the exercise therapy device 10 includes torque detection means 13. The torque detection means 13 is means for detecting a torque applied to the rotation portion 11, and is configured to transmit the detected torque to the control means 12. The torque detection means 13 can be formed of, for example, a publicly-known torque sensor or the like.

Moreover, the exercise therapy device 10 includes speed control means 14. The speed control means 14 is configured to control the rotational speed of the rotation portion 11. The speed control means 14 can be implemented based on a publicly-known configuration.

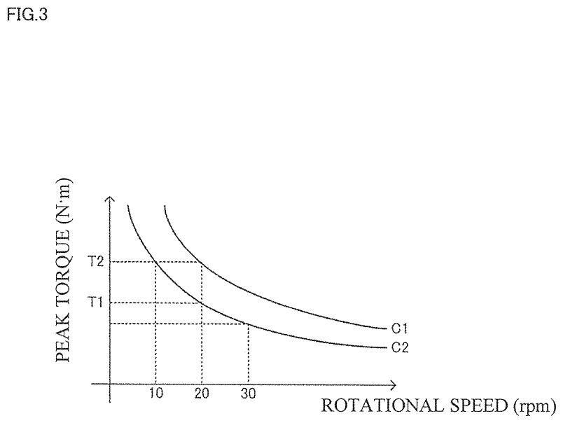

FIG. 3 is a graph for showing an example of an F-V characteristic in the isokinetic exercise in which the exercise therapy device 10 is used. The vertical axis represents a peak torque F. The horizontal axis represents a rotational speed V. Both curves C1 and C2 represent the F-V characteristic of the exercising person 20. The curve C1 corresponds to a case of a normal physical condition. The curve C2 corresponds to a case of a bad physical condition. When the exercise therapy device 10 is providing the isokinetic exercise at 20 (rpm), the exercising person 20 generates a torque T2 (N·m) under the normal physical condition, but can only generate a torque T1 (N·m) under the bad physical condition.

Due to characteristics of the human body, in the isokinetic exercise, as the rotational speed is reduced, the peak torque increases, and as the rotational speed is conversely increased, the peak torque decreases. That is, the curves C1 and C2 represent monotonically decreasing functions.

When the torque relating to the exercise decreases, an effect of the exercise therapy may decrease or may be lost. A muscle composition of the human includes muscles of a type I, muscles of a type IIa, and muscles of a type IIb. The type I relates to endurance. The type IIa and the type IIb relate to instantaneous force. Compared with training of the muscles of the type I, a higher load is required to train the muscles of the type IIa and the type IIb. When the maximum torque that the exercising person 20 can generate is Tp (N·m), a sufficient training effect of the muscles cannot be provided unless a load equal to higher than a torque at which the muscles of the type IIa and the type IIb are used, for example, a load equal to or higher than Tp×0.2 (N·m) is applied.

Therefore, in order to more reliably obtain the effect of the exercise therapy for muscular hypertrophy, it is required to maintain a torque (target torque) relating to the exercise as stably as possible. However, the torque that the exercising person 20 can generate changes depending on factors, for example, the physical condition. It is therefore required to change a motion speed (a speed instruction value for the isokinetic exercise, and means for instructing the number of rotations in an exercise in the case of a power exercise) of the exercise therapy device 10 in accordance with the state.

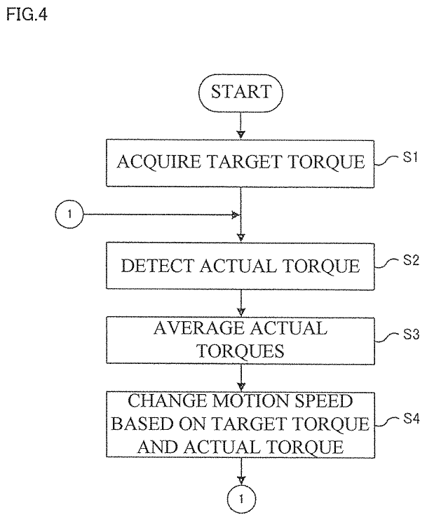

FIG. 4 is a flowchart for illustrating an example of a flow of processing by the exercise therapy device 10. The exercise therapy device 10 executes the processing of FIG. 4 in relation to the provision of the exercise therapy for the exercising person 20. In this embodiment, the exercise therapy device 10 is an isokinetic exercise therapy device configured to provide isokinetic exercise therapy, and the rotation portion 11 rotates at a constant number of rotations.

First, the control means 12 of the exercise therapy device 10 acquires the target torque (Step S1). This processing is executed by, for example, the target torque acquisition means. In this embodiment, the target torque is a torque reference value serving as a reference of the operation of the exercise therapy device 10.

The target torque to be acquired is, for example, input to the control means 12 before Step S1, and is stored in the storage means of the control means 12. A method of determining the target torque is any method. For example, the target torque may be obtained by multiplying an average (normative data) of the maximum leg extension torques of a large number of subjects by a predetermined ratio, or by multiplying an average of past maximum extension torques of a specific exercising person 20 by the predetermined ratio. An example of the maximum leg extension torque is the maximum torque generated while the exercising person 20 is pedaling with the maximum effort for a few rotations. When this ratio is lower than, for example, 0.2 corresponding to a torque at which the muscles of the type IIa and the type IIb are not used, the effect of the exercise therapy is reduced, and the ratio is thus required to correspond to a torque at which the muscles of the type IIa and the type IIb are used. For example, the ratio may be 0.5 or 0.8.

The exercising person 20 starts the use of the exercise therapy device 10 before or after Step S1, which is not shown in FIG. 4. That is, a torque is applied to the rotation portion 11 by both of the legs, to thereby rotate the rotation portion 11.

The control means 12 detects the torque applied to the rotation portion 11 (Step S2). For example, the torque detection means 13 detects the torque, and transmits a signal indicating the detected torque to the control means 12. The control means 12 receives the transmitted signal. Herein and in the accompanying drawings, in order to distinguish the detected torque from the target torque acquired in Step S1, the torque detected in Step S2 is sometimes referred to as “actual torque.”

After that, the control means 12 averages the actual torques (Step S3). This processing is executed by, for example, the torque averaging means. The averaging is cyclically executed. The cycle corresponds to, for example, 180 cycles (180 rotations) of the motion of the rotation portion 11. For example, when the exercising person 20 has a weak right leg and a strong left leg, a torque fluctuation including a weak torque generated at a moment of a depression by the right leg, a strong torque generated at a moment of a depression by the left leg, and a torque close to zero generated when none of the legs are strained is averaged.

After that, the exercise therapy device 10 executes processing for changing the rotational speed of the rotation portion 11 based on the actual torque (in this example, the averaged torque) for a few minutes and the target torque (Step S4). This processing is executed by, for example, the speed instruction means (isokinetic instruction value changing means) and the speed control means 14.

For example, when the actual torque is higher than the target torque, the control means 12 provides control of increasing the rotational speed of the rotation portion 11. More specifically, the control means 12 generates a predetermined speed instruction, and transmits the generated speed instruction to the speed control means 14. Details of the speed instruction in this case are, for example, increasing the rotational speed (in the isokinetic exercise) from the current rotational speed by a predetermined speed difference (for example, 1 rpm) when a predetermined period of time (for example, one minute) elapses. The speed control means 14 controls the rotation of the rotation portion 11 in accordance with this speed instruction. In this case, it is considered that the torque generated by the exercising person 20 decreases, and a torque closer in magnitude to the target torque can consequently be generated. As described above, an exercise at an excessively high torque is avoided.

In contrast, when the actual torque is lower than the target torque, the control means 12 provides control of decreasing the rotational speed of the rotation portion 11. More specifically, the control means 12 generates a predetermined speed instruction (speed control rotational speed), and transmits the generated speed instruction to the speed control means 14. Details of the speed instruction in this case are, for example, decreasing the rotational speed or the like (speed control rotational speed) from the current rotational speed by a predetermined speed difference when a predetermined period of time elapses. The speed control means 14 controls the rotation of the rotation portion 11 in accordance with this speed instruction. In this case, it is considered that the torque generated by the exercising person 20 increases, and a torque closer in magnitude to the target torque can consequently be generated. As described above, an exercise at an excessively low torque is avoided.

When the actual torque and the target torque are equal to each other, the control means 12 and the speed control means 14 are not required to particularly apply control to the rotation portion 11, or may apply control so that the rotational speed of the rotation portion 11 is maintained.

After that, the processing returns to Step S2, and the processing from Step S2 to Step S4 is repeated. Through the repetition of the processing, there is provided control of causing the actual torque to approach the target torque as the time elapses. Therefore, the magnitude of the torque is appropriately maintained, and the effect of the exercise therapy can thus be maintained.

As described above, according to the exercise therapy device 10 of the first embodiment of the present invention, the load on the exercising person 20 can more appropriately be adjusted.

### Second Embodiment

A second embodiment of the present invention is changed from the first embodiment such that the exercise therapy device 10 provides an exercise other than the isokinetic exercise. In the second embodiment, as the exercise other than the isokinetic exercise, the exercise therapy device 10 is configured to provide a power instruction exercise. Description is now given of the exercise therapy device according to the second embodiment.

In the power instruction exercise, the speed control means 14 is configured not to directly control the rotational speed of the rotation portion 11, but to give an instruction to change the motion speed to the exercising person 20 so as to indirectly change the rotational speed of the rotation portion 11. The speed control means 14 according to the third embodiment can be configured as information output means, and may be sound output means, for example, a speaker, or image display means, for example, a liquid crystal display.

On the basis of a relationship of “W=torque (N·m)×rotational speed (rpm) (r/min.)/9.55,” the torque can be increased by reducing the rotational speed for the same power.

Processing of from Step S1 to Step S3 is the same as that in the first embodiment. In Step S4, the control means 12 controls the speed control means 14, to thereby output information for changing the rotational speed of the rotation portion 11. For example, a pitch of a pitch sound output from a speaker is changed. The exercising person 20 rotates the rotation portion 11 so that the rotation matches the cycle of this pitch sound, and, as a result, the rotational speed is changed.

As described above, according to the exercise therapy device of the second embodiment of the present invention, as in the first embodiment, the load torque on the exercising person 20 can more appropriately be adjusted.

### Third Embodiment

A third embodiment of the present invention is changed from the first embodiment or the second embodiment such that the exercise therapy device 10 is configured to be able to operate in a plurality of modes. Description is now given of the exercise therapy device according to the third embodiment.

In the third embodiment, the exercise therapy device is configured to be able to operate in a torque reference determination mode and an exercise provision mode. Selection or switching of the mode in accordance with input from the exercising person 20 or the like can be implemented based on a publicly-known technology. For example, the exercise therapy device may include a mode selection switch.

The torque reference determination mode is a mode for determining the target torque to be acquired in Step S1 in the first embodiment. In the torque reference determination mode, the control means 12 is configured to determine a torque reference (for example, the target torque in the first embodiment) based on the measured torque.

The exercise provision mode is a mode for providing the exercise therapy. The operation of the exercise therapy device in the exercise provision mode may be the same as, for example, that of the exercise therapy device 10 according to the first embodiment. That is, in the exercise provision mode, the control means 12 is configured to execute processing for changing the motion speed of the rotation portion 11 based on the actual torque and the target torque.

A method of determining the torque reference in the torque reference determination mode can appropriately be designed, and description is now given of an example thereof.

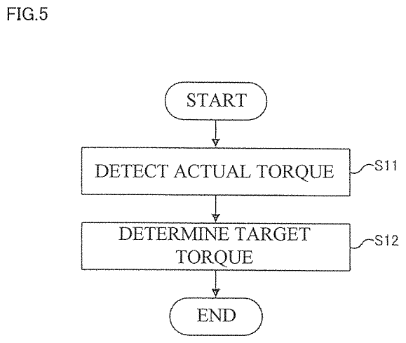

FIG. 5 is a flowchart for illustrating an example of a flow of processing by the exercise therapy device in the torque reference determination mode. First, the control means 12 detects a torque under a state in which the rotation portion 11 is fixed (Step S11). For example, the torque detection means 13 detects the torque, and transmits a signal indicating the detected torque to the control means 12. The control means 12 receives the transmitted signal. It is assumed that the exercising person 20 tries to rotate the rotation portion 11 with his or her full effort at this time.

After that, the control means 12 determines the torque reference (for example, the target torque) based on the detected torque (Step S12). For example, the torque reference is calculated by multiplying the torque detected in Step S11 by a predetermined ratio. When this ratio is lower than 0.2, the effect of the exercise therapy is reduced, and the ratio is thus required to be equal to or higher than 0.2. For example, the ratio may be 0.5 or 0.8.

The control means 12 may store the determined torque reference in the storage means. Moreover, in response to the finishing of the execution of the processing in Step S12, the mode may be switched from the torque reference determination mode to the exercise provision mode.

As described above, according to the exercise therapy device of the third embodiment of the present invention, as in the first embodiment, the load on the exercising person 20 can more appropriately be adjusted. Moreover, the torque reference is determined through the measurement of the actual torque, and hence the torque suited to the exercising person 20 can be set.

The following modifications may be made to the first embodiment to the third embodiment.

In the first embodiment to the third embodiment, the torque reference is the information indicating the magnitude of the torque, but the torque reference may be information indicating a range of the magnitude of the torque (torque reference range). For example, when the actual torque is within the torque reference range, the control means 12 may provide control of maintaining the rotational speed of the rotation portion 11. When the actual torque is higher than an upper limit of the torque reference range, the control means 12 may provide control of increasing the rotational speed of the rotation portion 11. When the actual torque is lower than a lower limit of the torque reference range, the control means 12 may provide control of reducing the rotational speed of the rotation portion 11.

In the first embodiment to the third embodiment, the actual torques are averaged in Step S3, but calculation other than the simple averaging may be executed in Step S3.

In the first embodiment, the movable portion is formed as the rotation portion 11, and the force applied to the rotation portion 11 is represented as the torque, but the movable portion is not required to rotate. For example, the movable portion may be a portion configured to perform a reciprocating motion, for example, an expander. In this case, instead of a torque, a force that reciprocates in a certain direction may be applied to the movable portion, and the exercise therapy device may be configured to operate based on not a torque but a more general moment or force. Moreover, in such a case, the rotational speed in the first embodiment to the third embodiment may be a more general motion speed.

### REFERENCE SIGNS LIST

10 exercise therapy device, 11 rotation portion (movable portion), 12 control means, 13 torque detection means (force detection means), 14 speed control means, 20 exercising person

1. An exercise therapy device including a movable portion, the exercise therapy device comprising:
a force detector for detecting a force applied to the movable portion; and
control circuitry for executing processing for changing a motion speed of the movable portion based on a force reference and the detected force.

2. The exercise therapy device according to claim 1, wherein the control circuitry is configured to:
increase the motion speed of the movable portion when the detected force is larger than the force reference; and
reduce the motion speed of the movable portion when the detected force is smaller than the force reference.

3. The exercise therapy device according to claim 1,
wherein the movable portion is configured to execute a circular motion, and
wherein the force is represented as a torque.

4. The exercise therapy device according to claim 1,
wherein the exercise therapy device is configured to operate in a force reference determination mode and an exercise provision mode, and
wherein the control circuitry is configured to:
determine the force reference based on the detected force in the force reference determination mode; and
execute the processing for changing the motion speed of the movable portion in the exercise provision mode.

5. The exercise therapy device according to claim 2,
wherein the movable portion is configured to execute a circular motion, and
wherein the force is represented as a torque.

6. The exercise therapy device according to claim 2,
wherein the exercise therapy device is configured to operate in a force reference determination mode and an exercise provision mode, and
wherein the control circuitry is configured to:
determine the force reference based on the detected force in the force reference determination mode; and
execute the processing for changing the motion speed of the movable portion in the exercise provision mode.

7. The exercise therapy device according to claim 3,
wherein the exercise therapy device is configured to operate in a force reference determination mode and an exercise provision mode, and
wherein the control circuitry is configured to:
determine the force reference based on the detected force in the force reference determination mode; and
execute the processing for changing the motion speed of the movable portion in the exercise provision mode.

8. The exercise therapy device according to claim 5,
wherein the exercise therapy device is configured to operate in a force reference determination mode and an exercise provision mode, and
wherein the control circuitry is configured to:
determine the force reference based on the detected force in the force reference determination mode; and
execute the processing for changing the motion speed of the movable portion in the exercise provision mode.
